(19) United States
(12) Patent Application Publication
(10) Pub. No.: US 2017/0087537 A1
(43) Pub. Date: Mar. 30, 2017

(54) MIXED METAL OXIDE CATALYSTS FOR AMMONIA DECOMPOSITION

(71) Applicant: SABIC GLOBAL TECHNOLOGIES B.V, Bergen Op Zoom (NL)

(72) Inventors: Hui Zhang, Jeddah (SA); Lachezar Angelov Petrov, Jeddah (SA); Yahia Abobakor Alhamed, Jeddah (SA); Abdulrahim Ahmed Alzahrani, Jeddah (SA); Mohammad Abdulrahman Daous, Jeddah (SA); Mohammed H. Alhazmi, Riyadh (SA)

(21) Appl. No.: 15/310,874

(22) PCT Filed: May 22, 2015
(86) PCT No.: PCT/IB2015/053799

§ 371 Date: Nov. 14, 2016

Related U.S. Application Data
(60) Provisional application No. 62/001,992, filed on May 22, 2014.

(51) Int. Cl. B01J 23/83; C01B 3/04; B01J 37/08; B01J 23/00; B01J 37/03; B01J 37/02

(52) U.S. Cl. CPC B01J 23/83; B01J 37/031; B01J 37/0236; B01J 37/082; B01J 23/002; C01B 3/047; B01J 2523/00

(57) ABSTRACT

Systems and methods for ammonia decomposition catalysts are described. Systems and methods may include providing a first solution, where the first solution includes a first metal soluble salt of cobalt, nickel, iron, and a combination thereof; a second metal soluble salt of magnesium, calcium, strontium, barium, and a combination thereof; a third metal soluble salt of lanthanide elements, and a combination thereof; and a fourth metal soluble salt of aluminum, transition metals, alkali metals, and a combination thereof. The first metal oxide, the second metal oxide, the third metal oxide, and the fourth metal oxide may be co-precipitated from the first solution at a pH between approximately 6.0 and approximately 11.0 to form a hydrotalcite-like structured material. The co-precipitated material may be aged and dried. The aged, dried, co-precipitated material may be decomposed to form a final catalyst product.

This application is a National Stage application of PCT/IB2015/053799, filed May 22, 2015, which claims the benefit of U.S. Provisional Application No. 62/001,992 filed May 22, 2014, both of which are incorporated herein by reference in their entirety.

### FIELD OF THE INVENTION

The present invention relates to systems and methods for ammonia decomposition catalysts, and more specifically, to mixed metal oxide catalysts and methods of producing mixed metal oxide catalysts.

### BACKGROUND OF THE INVENTION

Fuel cells are emerging as one of the most promising clean energy sources because of high efficiency and low environment pollution. Fuel cells have been extensively used in many fields including automotive, electronics, military, aerospace, etc. Some of the major obstacles for wide-spread adoption of commercial fuel cell applications include clean hydrogen production, hydrogen storage, transportation of hydrogen, and cost. Onboard hydrogen generation from liquid sources with high hydrogen density would be a desirable method to overcome one or more of these obstacles. Currently technology, however, does not provide for suitable onboard hydrogen generation from liquid sources with high hydrogen density.

Liquid ammonia, as a hydrogen carrier, has the advantages of both high energy density (approximately 3000 Wh/kg) and high hydrogen storage capacity (approximately 17.7 wt %), which makes ammonia suitable for on-site generation of CO_{N}-free hydrogen by catalytic ammonia decomposition (AD). Obtaining a high degree conversion of ammonia at working temperatures of fuel cells is a significant challenge to future practical applications. Therefore, the design and synthesis of highly efficient and stable ammonia catalyst is of great significance.

To commercialize hydrogen-powered vehicles, a gravimetrically and volumetrically large, high-pressure hydrogen storage tank must be developed that works under moderate conditions. High-pressure vessels, however, are costly, heavy, and not safe. Ammonia can be liquefied at a pressure of 1 MPa or less. Hydrogen could be generated by decomposing the ammonia onboard a vehicle. Therefore, the development of an improved ammonia decomposition catalyst is important to create a feasible solution to onboard hydrogen generation at low temperatures.

Techniques for producing hydrogen by ammonia decomposition are well-known. These techniques are generally not commercially feasible at fuel cell operating conditions, however, due to poor catalyst performance. Ammonia decomposition to hydrogen is an endothermic process. As such, a high degree of conversion requires high reaction temperatures and low partial pressures of the reactants.

Ammonia decomposition proceeds in the presence of a metal catalyst. Prior systems have focused on Ru-based supported catalysts. Group VIII metals (Ni, Ir, Fe, Co and Rh), as well as metal carbides and metal nitrides, have also been proven to catalyze the ammonia decomposition process. Ammonia decomposition proceeds with high velocity on Ru, Co, Ni, and Fe metal supported catalysts. The overall number of metal active sites in supported catalysts primarily depends on metal dispersion, which directly affects catalyst performance. Metal dispersion with adequate metal-support interaction is the key parameter in design of active catalysts for ammonia decomposition. Oxide carriers, including SiO₂, Al₂O₃, TiO₂, ZrO₂, or novel carbon materials such as mesoporous carbon or carbon nanotubes, are employed as catalyst supports.

Needs exist for improved systems and methods for improved catalyst performance for the conversion of ammonia to hydrogen, and methods of manufacture of the catalysts.

### SUMMARY OF THE INVENTION

Embodiments solve many of the problems and/or overcome many of the drawbacks and disadvantages of the prior art by providing systems and methods for mixed metal oxide catalysts for ammonia decomposition.

Embodiments may include systems and methods for mixed metal oxide catalysts for ammonia decomposition. The systems and methods may include providing a first solution, where the first solution may include one or more first metal soluble salts of cobalt, nickel, iron, and a combination thereof; one or more second metal soluble salts of magnesium, calcium, strontium, barium, and a combination thereof; one or more third metal soluble salts of lanthanides elements and a combination thereof; one or more fourth metal soluble salts of aluminum, transition metals, alkali metals, and a combination thereof. One or more first metal oxides, one or more second metal oxides, one or more third metal oxides, and one or more fourth metal oxides may be co-precipitated from the first solution at a pH between approximately 6.0 and approximately 11.0 to form a hydrotalcite-like structured material. The co-precipitated material may be aged. The co-precipitated material may be filtered and dried. The dried, co-precipitated material may be decomposed to form a final catalyst product.

Additional features, advantages, and embodiments of the invention are set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a graph of catalytic performance for cobalt containing mixed metal oxide catalyst in ammonia decomposition.

FIG. 2 shows a graph of H₂-TPR profiles of La promoted cobalt containing mixed metal oxide.

FIGS. 3-7 show X-ray photoelectron spectroscopy (XPS) Co 2p spectra of an CoMgLa catalyst showing the presence in the catalyst surface of all metal components in the final catalyst composition.

### DETAILED DESCRIPTION OF THE PREFERRED EMBODIMENTS

Systems and methods are described for integrated processes for catalysts used in ammonia decomposition, particularly mixed metal oxide catalysts. The processes described herein are exemplary processes only and used for illustrative purposes. Other variations and combinations of steps and components may be used as necessary.

Certain embodiments described herein are directed to a catalyst product. The catalyst product may be a cobalt-containing mixed metal oxide catalyst for ammonia decomposition. The catalyst may include: (1) one or more oxides of cobalt (Co), nickel (Ni), or iron (Fe), or a combination thereof; (2) one or more oxides of magnesium (Mg), calcium (Ca), strontium (Sr), barium (Ba), or a combination thereof; (3) one or more oxides of a lanthanide or a combination of oxides of at least two different lanthanides; and (4) one or more oxides of aluminum, transition metals, alkali metals, and a combination thereof. The catalyst may be produced by decomposition of a hydrotalcite-like structured intermediate form of the catalyst.

Certain embodiments described herein also include a method of preparation of mixed metal oxide catalysts for ammonia decomposition. In certain embodiments, a method of preparation may include co-precipitation of various metal oxides that may result in hydrotalcite-like structured materials. After co-precipitation, the prepared hydrotalcite-like structured material may be filtered and/or dried. The dried material may undergo a calcination stage to decompose the hydrotalcite-like structured material to a mixed metal oxide phase. Catalyst Compositions

Certain embodiments described herein may be directed to a catalyst product. The catalyst product may be a cobalt-containing mixed metal oxide catalyst for ammonia decomposition. In certain embodiments, a catalyst may include: (1) one or more oxides of cobalt (Co), nickel (Ni), iron (Fe), and a combination thereof; (2) one or more oxides of magnesium (Mg), calcium (Ca), strontium (Sr), barium (Ba), and a combination thereof; (3) one or more oxides of a lanthanide metal and a combination thereof; (4) one or more oxides of aluminum, transition metal oxides, alkali metal oxides, and a combination thereof.

A first metal oxide may preferably include a cobalt oxide, such as Co₃O₄. Other cobalt oxides may be possible and may be used in combination. In alternative embodiments, a nickel oxide or an iron oxide may also be used, such as NiO, Ni₂O₃, FeO, Fe₃O₄, Fe₄O₅, and Fe₂O₃. In certain embodiments, the first metal oxide may be mixtures of one or more of a cobalt oxide, nickel oxide, and/or iron oxide. In certain embodiments, the first metal oxide content of the final catalyst product may be less than approximately 30 weight percent of the final catalyst product. In certain embodiments, the first metal oxide content of the final catalyst product may be less than approximately 40 weight percent of the final catalyst product.

A second metal oxide may preferably be a magnesium oxide, such as MgO. Other alkaline earth metal oxides may be possible, such as a calcium oxide, a strontium oxide, and a barium oxide. In certain embodiments, the second metal oxide may be a mixture of one or more mixtures of alkaline earth metal oxides. In certain embodiments, the second metal oxide content of the final catalyst product may be between approximately 0.001 weight percent and approximately 50 weight percent. In certain embodiments, the second metal oxide content of the final catalyst product may be between approximately 0.001 weight percent and approximately 30 weight percent.

A third metal oxide may preferably be a lanthanide element oxide. “Lanthanides” as used herein includes the elements in the series of lanthanum through ytterbium (Yb). Preferred lanthanide oxides include La₂O₃, CeO₂, and Pr₂O₃. In certain embodiments, a lanthanum oxide may be used. Combinations of different lanthanide metal oxides may also be used. In certain embodiments, the third metal oxide content in the final catalyst product may be between approximately 0.001 weight percent to approximately 30 weight percent of the final catalyst product. In certain embodiments, the third metal oxide content in the final catalyst product may be between approximately 0.001 weight percent to approximately 15 weight percent of the final catalyst product.

A fourth metal oxide may be one or more of aluminum oxide (alumina), transition metal oxides, and/or alkali metal oxides. It is to be understood that the fourth metal oxide is not the same as the first, second or third metal oxide. Thus, possible transition metal oxides include scandium, titanium, vanadium, chromium, manganese, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, and rutherfordium. Preferred alkali metals are lithium, sodium, potassium, rubidium, and cesium, more particularly lithium, sodium, or potassium. Combinations of one or more various fourth metal oxides may be used in certain embodiments. In certain embodiments, the fourth metal oxide content of the final catalyst product may be between approximately 0.001 weight percent and approximately 30 weight percent.

In certain embodiments, particularly where no alumina is used, the fourth metal oxide may be a transition metal oxide or an alkali metal oxide. Alternatively it is possible to have no fourth metal oxide present in some embodiments.

Precipitated material as described herein forms an intermediate hydrotalcite-like structured intermediate form. The final catalyst product may be produced by decomposition of a hydrotalcite-like structured intermediate form of the catalyst.

In certain embodiments, the final catalyst product may include one or more cobalt oxides, one or more magnesium oxides, and one or more lanthanum oxides, optionally together with alumina. In certain embodiments, the final catalyst product may include Co₃O₄, MgO, Al₂O₃, La₂O₃, and CeO₂.

In certain embodiments, the final catalyst product may include Co₃O₄, MgO, Al₂O₃, and La₂O₃, in ratios such that the cobalt content is approximately 0.001 to 30.0 weight percent, the alumina content is approximately 0.001 to approximately 30.0 weight percent, and the magnesium content is approximately 0.001 to approximately 50.0 weight percent. In any of the foregoing embodiments, the lanthanide metal content can be approximately 0.001 to approximately 30.0 weight percent, or approximately 0.001 to approximately 20.0 weight percent. Each of the foregoing weight percents are based on the total weight of the final catalyst product.

In certain other embodiments, the final catalyst product may include Co₃O₄, MgO, Al₂O₃, and La₂O₃, in ratios such that the cobalt oxide content is approximately 0.001 to 30.0 weight percent, the alumina content is approximately 0.001 to approximately 30.0 weight percent, and the magnesium oxide content is approximately 0.001 to approximately 50.0 weight percent. In any of the foregoing embodiments, the lanthanum oxide content can be approximately 0.001 to approximately 30.0 weight percent, or approximately 0.001 to approximately 20.0 weight percent. Each of the foregoing weight percents are based on the total weight of the final catalyst product.

The final catalyst product may preferably operate at temperatures between approximately 350° C. and approximately 550° C.

### Production Methods

A first solution of mixed metal soluble salts including a first metal salt, a second metal salt, a third metal salt, and a fourth metal salt may be prepared. Soluble salts may include nitrates, chlorides, and other soluble salts of the corresponding first, second, third, and fourth metals used in the preparation of the first, second, third, and fourth metal oxides, respectively. The first solution may contain salts of the final catalyst's components. The solvent may be water. A small amount of other miscible solvents may be present, provided that they do not significantly adversely affect the formation of the catalyst.

The mixed metal oxides may be co-precipitated out of the mixed metal salt solution. The pH of the liquid phase during co-precipitation process may be controlled in the range of approximately 6.0 to approximately 11.0, more preferably approximately 7.0 to approximately 10.0, and more preferably between approximately 7.5 and approximately 9.0. The adjustment of the pH values may be achieved by the use of alkaline compounds, for example, sodium hydroxide or calcium hydroxide, or ammonia. Thus, it can be seen that the fourth metal oxide can be provided by adding a soluble aluminum salt a soluble transition metal salt, a soluble alkali metal salt, or an alkali metal hydroxide to adjust the pH of the mixed metal salt solution. If no aluminum salt is added, the fourth metal oxide may be derived from an alkali metal added as a base to adjust the pH. Where no soluble aluminum salt or soluble transition metal salt is added and the pH is adjusted with ammonia or calcium hydroxide, for example, the catalyst product may contain only the first, second, and third metal oxides.

The co-precipitation process may result in a hydrotalcite-like structured material including the first metal oxide, the second metal oxide, the third metal oxide, and the fourth metal oxide. Layered double hydroxides, also known as hydrotalcite-like compounds, are anionic clay materials that allow the uniform mixing of different bivalent and trivalent cations.

The reaction temperature during the co-precipitation process may be between approximately 40° C. and approximately 90° C. In certain embodiments the reaction temperature may be between approximately 55° C. and 80° C., or between approximately 60° C. and approximately 75° C.

In certain embodiments, the ranges of the catalyst components in the hydrotalcite-like structured material may be: MgO approximately 0.001-50 weight percent, Co approximately 0.001-30 weight percent, Al approximately 0.001-30 weight percent, and La approximately 0.001-20 weight percent, based on the total weight of the catalyst components. In certain other embodiments, the ranges of the catalyst components in the hydrotalcite-like structured material may be: MgO approximately 0.001-50 weight percent, cobalt oxide approximately 0.001-30 weight percent, aluminum oxide approximately 0.001-30 weight percent, and lanthanum oxide approximately 0.001-20 weight percent, based on the total weight of the catalyst components.

After co-precipitation, the obtained sludge containing the hydrotalcite-like structured material may be aged. In certain embodiments, the aging may be for 4 or more hours, more preferably 12 or more hours, more preferably 24 or more hours. In certain embodiments, no aging may be performed. The aging may be performed at a predetermined temperature. The predetermined temperature may be room temperature. In certain embodiments, the predetermined temperature may be approximately 0° C. to approximately 50° C.

The aged sludge containing the hydrotalcite-like structured material may be filtered and/or washed with distilled water. The aged sludge containing the hydrotalcite-like structure material may be dried. The hydrotalcite-like structured material may be dried in an oven. The oven may operate at a temperature of between approximately 50° C. and approximately 100° C., preferably between approximately 60° C. and approximately 90° C., preferably between approximately 65° C. and approximately 80° C.

The dried hydrotalcite-like structured material may undergo a calcination stage. The calcination stage may take place in air or nitrogen flow between approximately 100° C. to approximately 800° C., more preferably at approximately 500° C. to approximately 600° C. In the calcination stage the hydrotalcite-like structured material should be decomposed to yield a mixed metal oxide phase as a final catalyst product. A homogenous mixture of metal oxides with small crystal size, high dispersion, and large specific surface area may be obtained by the decomposition of hydrotalcite. This method of calcination may further ensure formation of active cobalt species with spinel-like or corundum structures.

In certain embodiments, the catalyst preparation may result in high catalyst dispersion. In certain embodiments, co-precipitation may favor the formation of high concentrations of active sites and may lead to stronger metal-support interactions. In certain embodiments, the resulting mixed metal oxide catalysts of this invention may be very active for ammonia decomposition at low temperatures and may present excellent catalyst stability for ammonia decomposition.

In certain embodiments, the third metal oxide, (the lanthanide metal oxide) may provide a structure that forms physical and chemical bonds with the first metal oxide, such as one or more cobalt oxides, the one or more second metal oxides, such as magnesium oxides, and the one or more fourth metal oxides, such as aluminum oxide.

### EXAMPLES

### Example 1

Preparation of the cobalt containing catalysts.

Cobalt containing mixed metal oxide compounds were prepared by co-precipitation methods.

In an exemplary method, precursor solutions were obtained by dissolving purity grade nitrate salts of the corresponding metals in distilled water: 2.47 g Co(NO₃)₂ 6H₂O, 18.7 g Mg(NO₃)₃, 10.4 g Al(NO₃)₃ and 2.238 g La(NO₃)₃. A solution of 0.1 M NaOH for use as a precipitation agent was prepared.

The metal salt solutions were mixed to form a first solution. This resulted in a mixed Co, Al, La, and Mg metal salt solution.

A volume of distilled water was placed in a beaker, heated to 65° C. and pH was adjusted with 0.1 M NaOH to reach pH=8.0. This is referred to as a second solution. The first solution (mixed Co, Al, La, and Mg metal salt solution) and precipitant were introduced simultaneously to the second solution under vigorous stirring. A slurry was obtained. The resulting slurry was aged for 24 h in the mother liquor. The slurry was then filtered off and thoroughly washed several times with distilled water. The precipitate was mixed with 100 ml distilled water and then dried at 65° C. in a rotary evaporate machine under a vacuum (200 mbar). The dried material was dried in an oven at 75° C. for four hours. The obtained sample was further calcined at 500° C. for 5 hours to provide a final catalyst product containing oxides of cobalt, magnesium, aluminum, and lanthanum.

### Example 2

Testing of the catalytic activity for ammonia decomposition.

The testing of the catalysts for ammonia decomposition to hydrogen and nitrogen was carried out in Microactivity-Reference (PID Eng & Tech, Madrid, Spain). A 0.5-1.0 g sample with grain size of 125-250 μm was introduced into a quartz reactor (ID 6.0 mm) and activated at 600° C. for 5 h with pure hydrogen flow. After the reduction process was finished, the reactor temperature was decreased to 350° C. and hydrogen flow was replaced with pure ammonia flow with Gas Hourly Space Velocities (GHSV) of 1200 h⁻¹. The reaction temperature was varied between 350° C. and 600° C.

The analysis of the inlet and outlet gas from reactor was performed by on-line connected gas chromatograph (GC-450 Varian, USA) equipped with a thermal conductivity detector and a Poropak Q column.

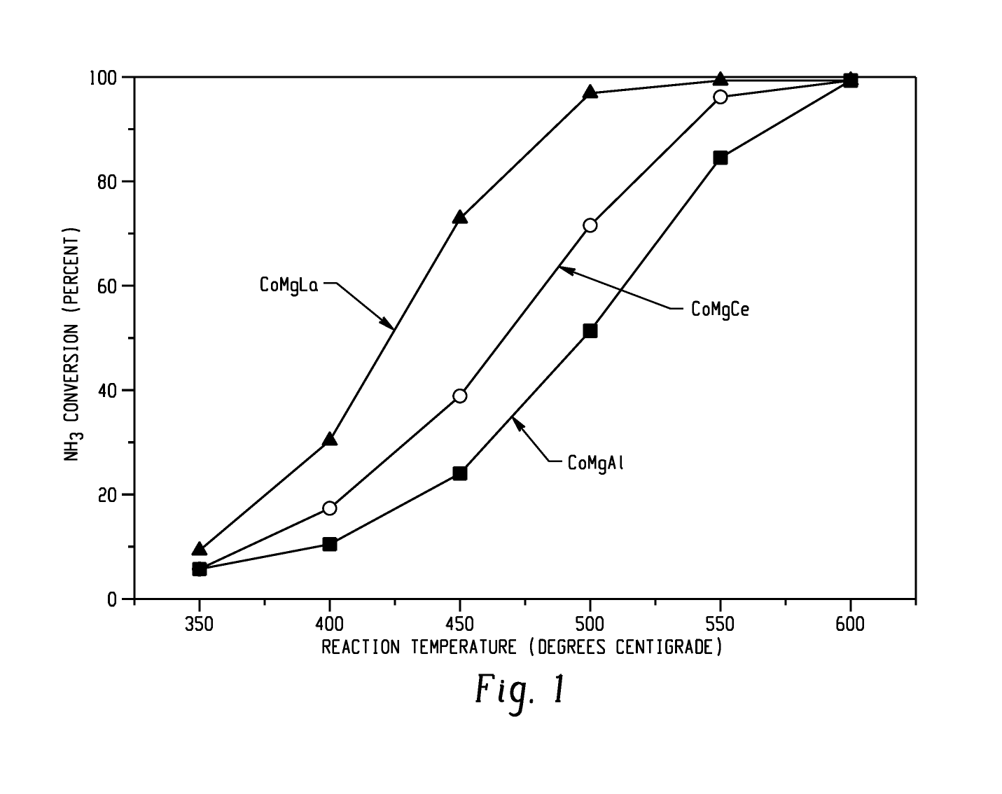

In FIG. 1, the experimental data of catalytic properties testing in the reaction of ammonia decomposition are presented according to the prepared catalyst in Example 1.

The catalyst sample containing Co, Mg, and La shows excellent catalytic activity at temperatures below 500° C.

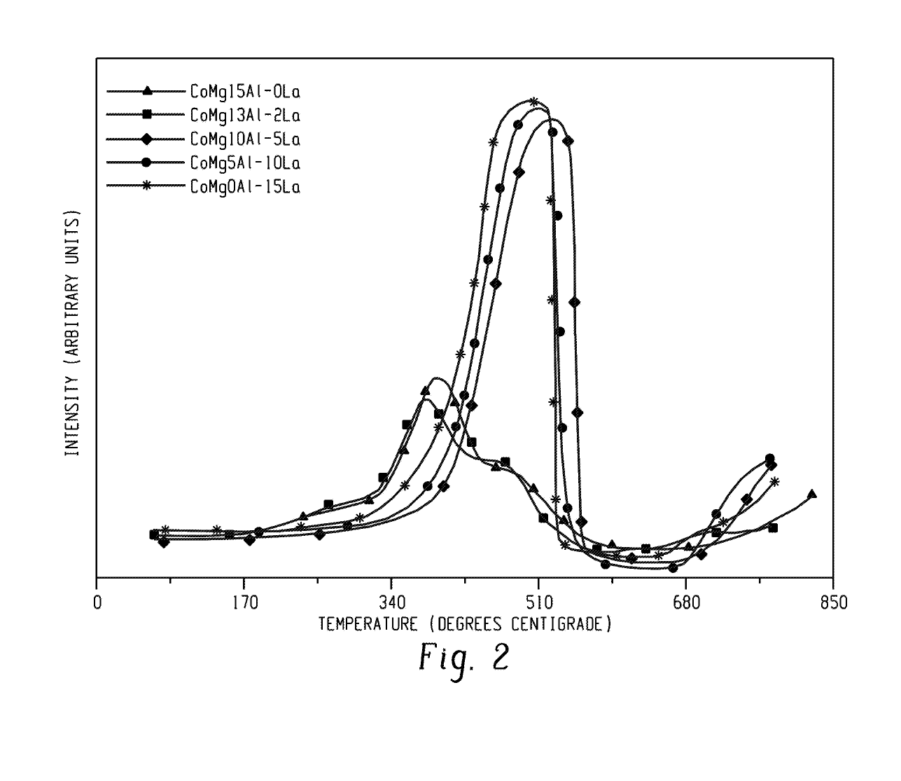

FIG. 2 shows a graph of H₂-TPR profiles of La promoted cobalt containing mixed metal oxide. As the content of La is increased, the maximum of the hydrogen consumption peaks is decreased by approximately 150° C. Therefore, because of the presence of La in the catalyst composition, the reduction of Co particles proceeded with much lower activation energy. The result is that the number of cobalt active sites increased and catalytic activity of the catalyst correspondingly was higher.

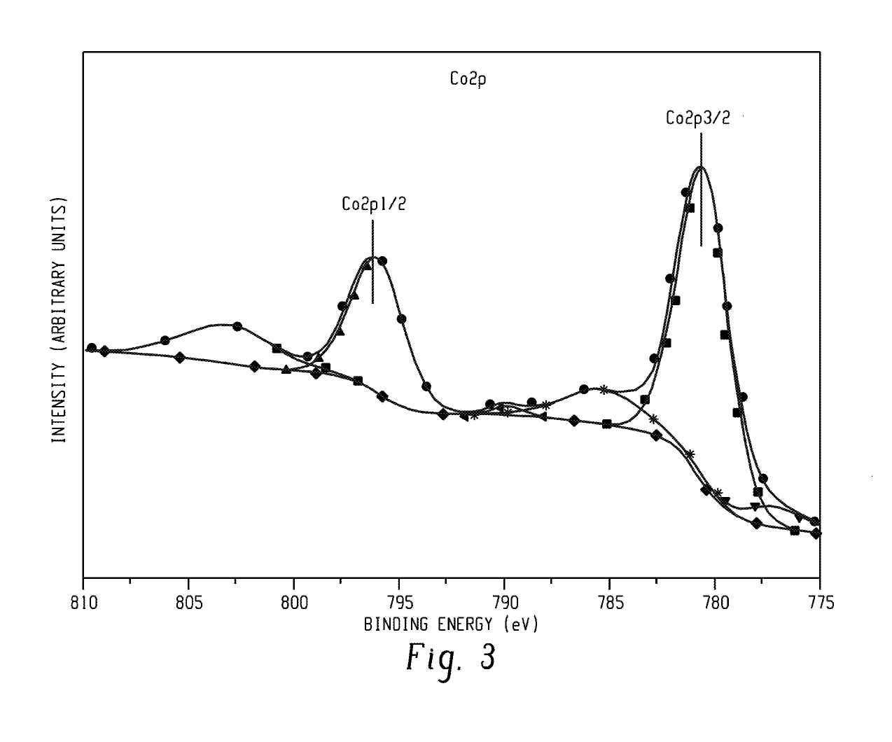

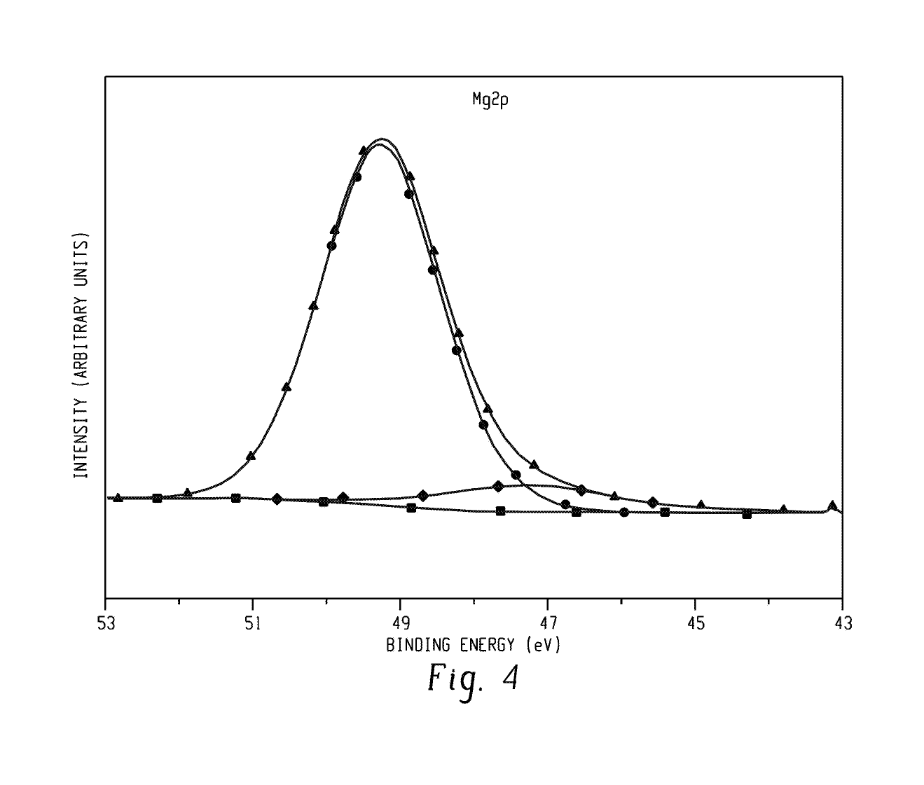

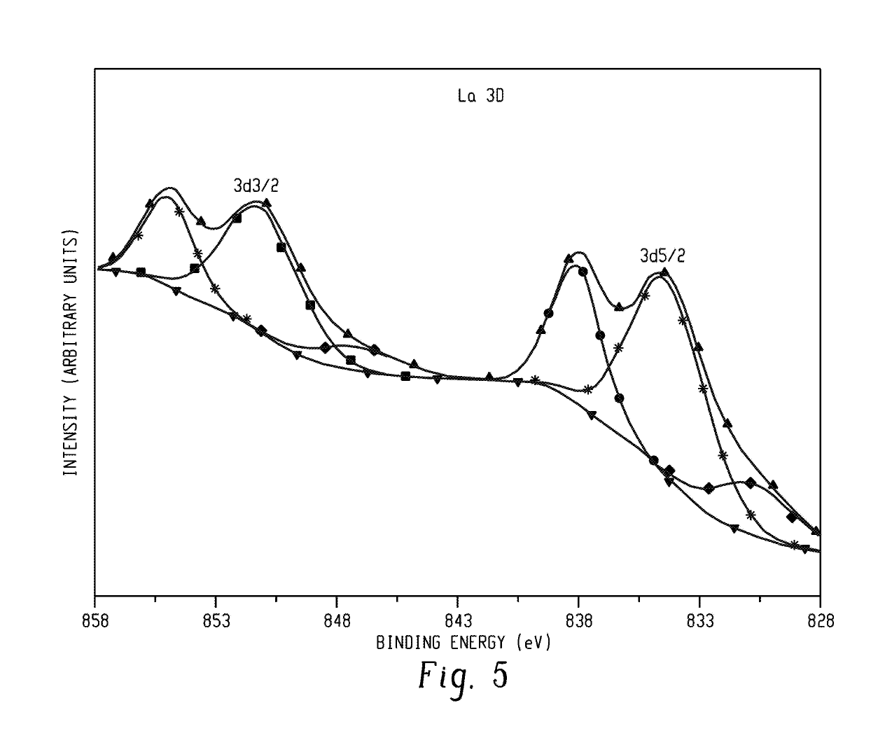

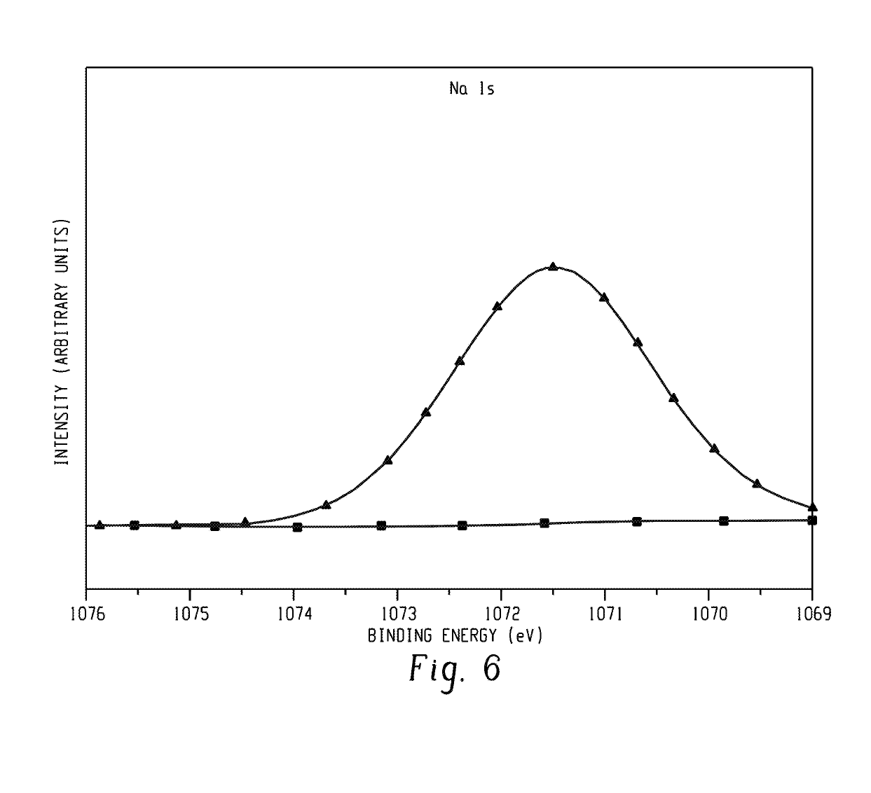

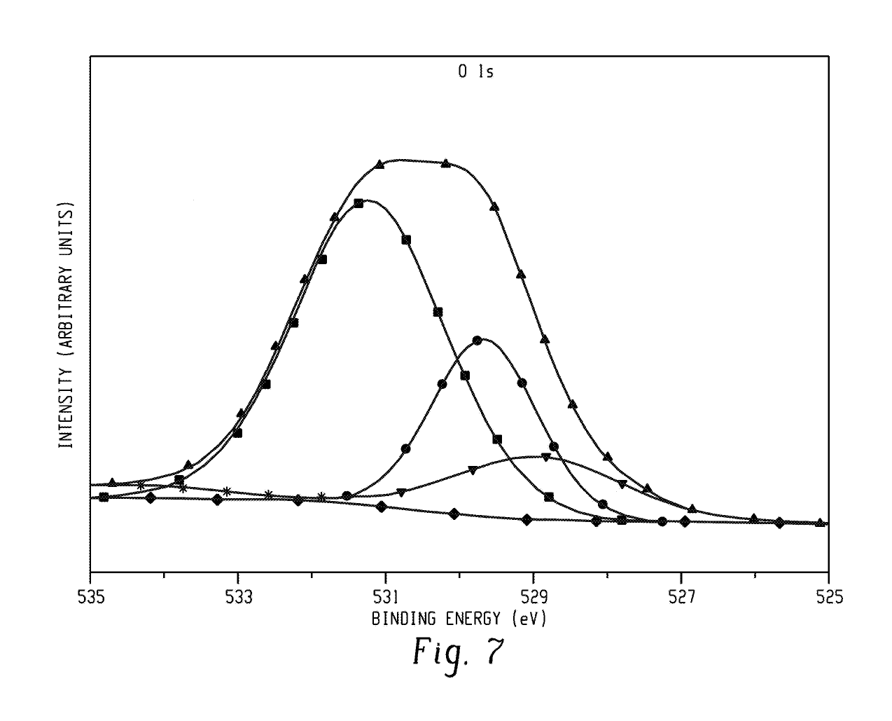

FIGS. 3-7 show X-ray photoelectron spectroscopy (XPS) Co 2p spectra of CoMgLa-alumina catalyst showing the presence of all components in final catalyst composition. This data relates to the composition tested in FIG. 2.

The invention is still further illustrated by the following embodiments, which are not intended to limit the claims.

### Embodiment 1.

A method for preparing a catalyst for ammonia decomposition, the method comprising: providing a first solution comprising: a first metal soluble salt selected from cobalt soluble salts, nickel soluble salts, iron soluble salts, and a combination thereof; a second metal soluble salt selected from magnesium soluble salts, calcium soluble salts, strontium soluble salts, barium soluble salts, and a combination thereof; a third metal soluble salt selected from lanthanide soluble salts and a combination thereof; and a optionally, a fourth metal soluble salt selected from aluminum soluble salts, transition metal soluble salts, alkali metal soluble salts, and a combination thereof; co-precipitating a first metal oxide, a second metal oxide, a third metal oxide, and optionally a fourth metal oxide from the first solution at a pH between approximately 6.0 and approximately 11.0 to form a hydrotalcite-like structured material; and decomposing the hydrotalcite-like structured material to form the catalyst.

### Embodiment 2

The method of Embodiment 1, wherein the fourth metal soluble salt and the fourth metal oxide is present.

### Embodiment 3

The method of Embodiment 1 or Embodiment 2, wherein the first metal oxide comprises a cobalt oxide, preferably wherein the cobalt content of the hydrotalcite-like structured material is between approximately 0.001 weight percent and approximately 30 weight percent.

### Embodiment 4

The method of any one or more of Embodiments 1 to 3, wherein magnesium content of the hydrotalcite-like structured material is between approximately 0.001 weight percent and approximately 50 weight percent.

### Embodiment 5

The method of any one or more of any one or more of Embodiments 1 to 4, wherein the third metal oxide comprises a lanthanum oxide, preferably wherein the lanthanum oxide content of the hydrotalcite-like structured material is between approximately 0.001 weight percent and approximately 30 weight percent.

### Embodiment 6

The method of any one or more of any one or more of Embodiments 1 to 5, wherein the fourth metal oxide is present, preferably wherein the fourth metal oxide comprises an aluminum oxide, preferably wherein the aluminum oxide content of the hydrotalcite-like structured material is between approximately 0.001 weight percent and approximately 30 weight percent.

### Embodiment 7

The method of any one or more of Embodiments 1 to 6, further comprising adding the first solution to a second solution, which is an aqueous solution at a pH between approximately 6.0 and approximately 11.0.

### Embodiment 8

The method of any one or more of Embodiments 1 to 7, further comprising aging the co-precipitated material.

### Embodiment 9

The method of any one or more of Embodiments 1 to 8, wherein the aging comprises aging the co-precipitated material for approximately 24 hours in the first solution.

### Embodiment 10

The method of any one or more of Embodiment s 1 to 9, further comprising drying the co-precipitated material, or drying the aged material

### Embodiment 11

The method of any one or more of Embodiments 1 to 10, wherein the drying is performed at approximately 80° C.

### Embodiment 12

The method of any one or more of Embodiments 1 to 11, wherein the decomposing comprises a calcination stage between approximately 100° C. to approximately 800° C.

### Embodiment 13

The method of any one or more of Embodiments 1 to 12, wherein the catalyst comprises Co₃O₄, MgO, Al₂O₃, and La₂O₃.

### Embodiment 14

A catalyst for ammonia decomposition made by the process of any one or more of Embodiments 1 to 13.

### Embodiment 15

A catalyst for ammonia decomposition, the catalyst comprising: a first metal oxide selected from a cobalt oxide, a nickel oxide, and an iron oxide, and a combination thereof; a second metal oxide selected from a magnesium oxide, a calcium oxide, a strontium oxide, a barium oxide, and a combination thereof; a third metal oxide selected from a lanthanide metal oxide; and optionally, a fourth metal oxide selected from an aluminum oxide, a transition metal oxide, an alkali metal oxide, and a combination thereof, wherein the catalyst is formed by co-precipitation of the first metal oxide, the second metal oxide, the third metal oxide, and the optional fourth metal oxide to form a hydrotalcite-like structured material that is then decomposed.

### Embodiment 16

The catalyst of Embodiment 15, wherein the fourth metal oxide is present.

### Embodiment 17

The catalyst of Embodiment 15 or Embodiment 16, wherein the first metal oxide comprises a cobalt oxide, preferably wherein the cobalt oxide content is between approximately 0.001 weight percent and approximately 30 weight percent.

### Embodiment 18

The catalyst of any one or more of Embodiments 15 to 17, wherein the second metal oxide content is between approximately 0.001 weight percent and approximately 50 weight percent.

### Embodiment 19

The catalyst of any one or more of Embodiments 15 to 18, wherein the third metal oxide comprises a lanthanum oxide, preferably wherein the lanthanum oxide content of the hydrotalcite-like structured material is between approximately 0.001 weight percent and approximately 15 weight percent.

### Embodiment 20

The catalyst of any one or more of Embodiments 15 to 19, wherein the fourth metal oxide comprises an aluminum oxide, preferably wherein the aluminum oxide content is between approximately 0.001 weight percent and approximately 30 weight percent.

### Embodiment 21

A method for preparing a catalyst for ammonia decomposition, the method comprising: providing a first solution comprising: a first metal soluble salt selected from cobalt soluble salts, nickel soluble salts, iron soluble salts, and a combination thereof; a second metal soluble salt selected from magnesium soluble salts, calcium soluble salts, strontium soluble salts, barium soluble salts, and a combination thereof; a third metal soluble salt selected from lanthanide soluble salts and a combination thereof; and a fourth metal soluble salt selected from aluminum soluble salts, transition metal soluble salts, alkali metal soluble salts, and a combination thereof; co-precipitating a first metal oxide, a second metal oxide, a third metal oxide, and a fourth metal oxide from the first solution at a pH between approximately 6.0 and approximately 11.0 to form a hydrotalcite-like structured material; and decomposing the hydrotalcite-like structured material to form the catalyst.

### Embodiment 22

The method of Embodiment 21, wherein the first metal oxide comprises a cobalt oxide, preferably wherein the cobalt content of the hydrotalcite-like structured material is between approximately 0.001 weight percent and approximately 30 weight percent.

### Embodiment 23

The method of any one or more of Embodiments 21 to 22, wherein magnesium content of the hydrotalcite-like structured material is between approximately 0.001 weight percent and approximately 50 weight percent.

### Embodiment 24

The method of any one or more of Embodiments 21 to 23, wherein the third metal oxide comprises a lanthanum oxide, preferably wherein the lanthanum oxide content of the hydrotalcite-like structured material is between approximately 0.001 weight percent and approximately 30 weight percent.

### Embodiment 25

The method of any one or more of Embodiments 21 to 24, wherein the fourth metal oxide comprises an aluminum oxide, preferably wherein the aluminum oxide content of the hydrotalcite-like structured material is between approximately 0.001 weight percent and approximately 30 weight percent.

### Embodiment 26

The method of any one or more of Embodiments 21 to 25, further comprising adding the first solution to a second solution, which is an aqueous solution at a pH between approximately 6.0 and approximately 11.0.

### Embodiment 27

The method of any one or more of Embodiments 21 to 26, further comprising aging the co-precipitated material.

### Embodiment 28

The method of any one or more of Embodiments 21 to 27, wherein the aging comprises aging the co-precipitated material for approximately 24 hours in the first solution.

### Embodiment 29

The method of any one or more of Embodiments 21 to 28, further comprising drying the co-precipitated material, or drying the aged material.

### Embodiment 30

The method of any one or more of Embodiments 21 to 29, wherein the drying is performed at approximately 80° C.

### Embodiment 31

The method of cl any one or more of Embodiments 21 to 30, wherein the decomposing comprises a calcination stage between approximately 100° C. to approximately 800° C.

### Embodiment 32

The method of any one or more of Embodiments 21 to 31, wherein the catalyst comprises Co₃O₄, MgO, Al₂O₃, and La₂O₃.

### Embodiment 33

A catalyst for ammonia decomposition made by the process of any one or more of Embodiments 21 to 32.

### Embodiment 34

A catalyst for ammonia decomposition, the catalyst comprising: a first metal oxide selected from a cobalt oxide, a nickel oxide, and an iron oxide, and a combination thereof; a second metal oxide selected from a magnesium oxide, a calcium oxide, a strontium oxide, a barium oxide, and a combination thereof; and a third metal oxide selected from a lanthanide metal oxide; a fourth metal oxide selected from an aluminum oxide, a transition metal oxide, an alkali metal oxide, and a combination thereof, wherein the catalyst is formed by co-precipitation of the first metal oxide, the second metal oxide, the third metal oxide, and the fourth metal oxide to form a hydrotalcite-like structured material that is then decomposed.

### Embodiment 35

The catalyst of Embodiment 34, wherein the first metal oxide comprises a cobalt oxide, preferably wherein the cobalt oxide content of the hydrotalcite-like structured material is between approximately 0.001 weight percent and approximately 30 weight percent.

### Embodiment 36

The catalyst of any one or more of Embodiments 34 to 35, wherein the second metal oxide content of the hydrotalcite-like structured material is between approximately 0.001 weight percent and approximately 50 weight percent.

### Embodiment 37

The catalyst of any one or more of Embodiments 34 to 36, wherein the third metal oxide comprises a lanthanum oxide, preferably wherein the lanthanum oxide content of the hydrotalcite-like structured material is between approximately 0.001 weight percent and approximately 15 weight percent.

### Embodiment 38

The catalyst of any one or more of Embodiments 34 to 37, wherein the fourth metal oxide comprises an aluminum oxide, preferably wherein the fourth metal oxide content of the hydrotalcite-like structured material is between approximately 0.001 weight percent and approximately 30 weight percent.

### Embodiment 39

The catalyst of any one or more of Embodiments 35 to 38, comprising Co₃O₄, MgO, Al₂O₃, and La₂O₃.

In general, the compositions or methods may alternatively comprise, consist of, or consist essentially of, any appropriate components or steps herein disclosed. The invention may additionally, or alternatively, be formulated so as to be devoid, or substantially free, of any components, materials, ingredients, adjuvants, or species, or steps used in the prior art compositions or that are otherwise not necessary to the achievement of the function and/or objectives of the present claims.

The terms “a” and “an” as used herein and in the claims do not denote a limitation of quantity, but rather denote the presence of one or more of the referenced item. The term “or” means “and/or” unless clearly indicated otherwise by context.

“Approximately” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “approximately” can mean within one or more standard deviations.

The endpoints of all ranges directed to the same component or property are inclusive of the endpoints, are independently combinable, and include all intermediate points and ranges (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” such as about 10 wt % to about 23 wt %, etc.).

The terms “first,” “second,” and the like, “primary,” “secondary,” and the like, as used herein do not denote any order, quantity, or importance, but rather are used to distinguish one element from another.

Unless defined otherwise, technical and scientific terms used herein have the same meaning as is commonly understood by one of skill in the art to which this invention belongs.

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A method for preparing a catalyst for ammonia decomposition, the method comprising:
providing a first solution comprising:
a first metal soluble salt selected from cobalt soluble salts, nickel soluble salts, iron soluble salts, and a combination thereof;
a second metal soluble salt selected from magnesium soluble salts, calcium soluble salts, strontium soluble salts, barium soluble salts, and a combination thereof;
a third metal soluble salt selected from lanthanide soluble salts and a combination thereof; and
a optionally, a fourth metal soluble salt selected from aluminum soluble salts, transition metal soluble salts, alkali metal soluble salts, and a combination thereof;
co-precipitating a first metal oxide, a second metal oxide, a third metal oxide, and optionally a fourth metal oxide from the first solution at a pH between approximately 6.0 and approximately 11.0 to form a hydrotalcite-like structured material; and
decomposing the hydrotalcite-like structured material to form the catalyst.

2. The method of claim 1, wherein the fourth metal soluble salt and the fourth metal oxide is present.

3. The method of claim 1 or claim 2, wherein the first metal oxide comprises a cobalt oxide.

4. The method of claim 1, wherein a magnesium content of the hydrotalcite-like structured material is between approximately 0.001 weight percent and approximately 50 weight percent.

5. The method of claim 1, wherein the third metal oxide comprises a lanthanum oxide.

6. The method of claim 1, wherein the fourth metal oxide is present, wherein the fourth metal oxide comprises an aluminum oxide.

7. The method of claim 1, further comprising adding the first solution to a second solution, which is an aqueous solution at a pH between approximately 6.0 and approximately 11.0.

8. The method of claim 1, further comprising aging the co-precipitated material.

9. The method of claim 8, wherein the aging comprises aging the co-precipitated material for about 24 hours in the first solution.

10. The method of claim 1, further comprising drying the co-precipitated material, or drying the aged material.

11. The method of claim 10, wherein the drying is performed at approximately 80° C.

12. The method of claim 1, wherein the decomposing comprises a calcination stage between approximately 100° C. to approximately 800° C.

13. The method of claim 1, wherein the catalyst comprises Co₃O₄, MgO, Al₂O₃, and La₂O₃.

14. A catalyst for ammonia decomposition made by the method of claim 1.

15. A catalyst for ammonia decomposition, the catalyst comprising:
a first metal oxide selected from a cobalt oxide, a nickel oxide, and an iron oxide, and a combination thereof;
a second metal oxide selected from a magnesium oxide, a calcium oxide, a strontium oxide, a barium oxide, and a combination thereof;
a third metal oxide selected from a lanthanide metal oxide; and
optionally, a fourth metal oxide selected from an aluminum oxide, a transition metal oxide, an alkali metal oxide, and a combination thereof,
wherein the catalyst is formed by co-precipitation of the first metal oxide, the second metal oxide, the third metal oxide, and the optional fourth metal oxide to form a hydrotalcite-like structured material that is then decomposed.

16. The catalyst of claim 15, wherein the fourth metal oxide is present.

17. The catalyst of claim 15, wherein the first metal oxide comprises a cobalt oxide.

18. The catalyst of claim 15, wherein the second metal oxide content is between approximately 0.001 weight percent and approximately 50 weight percent.

19. The catalyst of claim 15, wherein the third metal oxide comprises a lanthanum oxide.

20. The catalyst of claim 15, wherein the fourth metal oxide comprises an aluminum oxide.
